(19) United States
(12) Patent Application Publication
(10) Pub. No.: US 2024/0201961 A1
(43) Pub. Date: Jun. 20, 2024

(54) INTELLIGENT WORKFLOW DESIGN FOR ROBOTIC PROCESS AUTOMATION

(71) Applicant: UiPath, Inc., New York, NY (US)

(72) Inventors: Kartik IYER, Bengaluru (IN); Bogdan-Constantin RIPA, Bucharest (RO)

(73) Assignee: UiPath, Inc., New York, NY (US)

(21) Appl. No.: 18/593,712

(22) Filed: Mar. 1, 2024

Related U.S. Application Data
(63) Continuation of application No. 16/774,077, filed on Jan. 28, 2020, now abandoned.

(30) Foreign Application Priority Data
Nov. 28, 2019 (IN) 201911048942

(51) Int. Cl. G06F 8/35; G06F 11/30; G06N 20/00

(52) U.S. Cl. CPC G06F 8/35; G06F 11/302; G06N 20/00

(57) ABSTRACT

An intelligent workflow design solution is provided that assists a user (e.g., developer of RPA workflows) by automatically and intelligently recommending suggested activities for use in building sequences of activities in an RPA workflow. The solution utilizes a predictive learning model to customize and personalize the workflow design process for a user, thereby shortening design cycle time and improving efficiency. A system and method for developing an RPA workflow includes monitoring one or more activities that are selected by a user and identifying one or more recommended activities as candidate next activities in a sequence based on a predictive learning model. The candidate next activities are generated for selection by the user and the predictive learning model is trained based on an actual selection by the user of a next activity for the sequence.

### CROSS-REFERENCE TO RELATED APPLICATIONS

This application is a continuation of prior-filed U.S. patent application Ser. No. 16/774,077, filed Jan. 28, 2020, which is based upon and claims the benefit of priority from Indian Patent Application Serial No. 201911048942, filed Nov. 28, 2019; the disclosures of all of which are incorporated herein by reference in their entirety.

### TECHNICAL FIELD

The present invention relates generally to robotic process automation (RPA), and more particularly to the development of RPA-enabled workflows using a predictive model for customization and personalization.

### BACKGROUND

Robotic process automation (RPA) is a form of process automation that can be implemented to automate repetitive and/or labor-intensive tasks, thereby reducing costs and increasing efficiency. As such, RPA has become prominent in the field of desktop automation and, in particular, for automating business processes.

RPA is implemented by developing workflows and deploying software robots for performing activities in the workflows. A typical RPA-enabled workflow includes one or more activities (e.g., a custom set of steps) that are selected by a user (e.g., sometimes referred to as a developer) to perform an automated task using attended and/or unattended robots. In developing workflows, a developer may select a common sequence or pattern of activities, sometimes on a repeated basis, due to several factors. For example, the logic of a particular business process (i.e., business logic) may require that activity Y follows activity X in a sequence. User-specific factors, such as coding style of the user, user preferences, and other factors relating to behaviors of the individual user may also influence the selection of activities in the course of designing RPA workflows. For example, a user may have a coding style in which the user prefers to select activity Y to follow activity X in a sequence.

Accounting for business logic and user-specific factors can complicate RPA workflow design. Developing workflows may also involve many steps and require a considerable amount of time searching for the next logical activity. Workflows that require longer sequences of activities can also add complexity to the development task.

### SUMMARY

These and other issues are addressed, in accordance with the various embodiments, with an intelligent workflow design solution that assists a user (e.g., developer of RPA workflows) by automatically and intelligently recommending suggested activities for use in building sequences of activities in an RPA workflow. The solution utilizes a predictive learning model to customize and personalize the workflow design process for a user, thereby shortening design cycle time and improving efficiency.

In an embodiment, a computer-implemented method is provided for developing an RPA workflow including a sequence of activities by monitoring one or more activities that are selected by the user for the RPA workflow and identifying one or more recommended activities as candidate next activities for the sequence based on a predictive learning model. Suggested next activities are generated for selection, the suggested next activities including one or more of the candidate next activities. The predictive learning model is trained based on an actual selection by the user of a next activity for the sequence.

Other embodiments include a system and a computer program embodied on a non-transitory computer-readable medium, for developing a robotic process automation (RPA) workflow including a sequence of activities, in accordance with the computer-implemented method described above.

In one or more embodiments, monitoring of the one or more activities selected by the user and generating the candidate next activities by the predictive learning model is performed substantially in real-time during development of the RPA workflow. In some embodiments, the suggested next activities are generated by evaluating the candidate next activities in the context of a user-specific pattern corresponding to past selections of activities and, based on that evaluation, personalizing the suggested next activities (e.g., based on user-specific considerations, removing one or more of the candidate next activities, adding other activities, and/or various combinations thereof). In other embodiments, identifying the one or more recommended activities is based on intelligence-based filtering to identify commonly used activities relevant to the RPA workflow. In various embodiments, the predictive learning model is trained by storing an inventory of commonly used activities relevant to the RPA workflow, storing an inventory of past selections of activities corresponding to a user, and updating the predictive learning model based on the commonly used activities, the past selections of activities, and the current activity selections by the user that are being monitored. According to one or more embodiments, the predictive learning model uses artificial intelligence, which may be based on models that use filtering, ranking or deep learning.

These and other advantages will be apparent to those of ordinary skill in the art by reference to the following detailed description and the accompanying drawings.

### BRIEF DESCRIPTION OF THE DRAWINGS

FIG. 1 is an architectural diagram illustrating a robotic process automation (RPA) system in accordance with one or more embodiments;

FIG. 2 is an architectural diagram illustrating an example of a deployed RPA system in accordance with one or more embodiments;

FIG. 3 is an architectural diagram illustrating a simplified deployment example of an RPA system in accordance with one or more embodiments;

FIG. 4 is a block diagram illustrating a system for developing RPA-enabled workflows in accordance with one or more embodiments;

FIG. 5 is a flowchart illustrating a method for developing RPA-enabled workflows in accordance with one or more embodiments;

FIG. 6 shows an illustrative workflow diagram in accordance with one or more embodiments;

FIGS. 7A through 7H show various screenshots illustrating a use case developing RPA-enabled workflows in accordance with one or more embodiments; and

FIG. 8 shows a high-level block diagram of a computing system according to one or more embodiments.

### DETAILED DESCRIPTION

Various illustrative embodiments will now be described more fully with reference to the accompanying drawings in which some of the illustrative embodiments are shown. It should be understood, however, that there is no intent to limit illustrative embodiments to the particular forms disclosed, but on the contrary, illustrative embodiments are intended to cover all modifications, equivalents, and alternatives falling within the scope of the claims. Where appropriate, like numbers refer to like elements throughout the description of the figures. It will be understood that, although terms such as first, second, etc. may be used herein to describe various elements, these elements should not be limited by these terms. These terms are only used to distinguish one element from another. For example, a first element could be termed a second element, and, similarly, a second element could be termed a first element, without departing from the scope of illustrative embodiments. As used herein, the term “and/or” includes any and all combinations of one or more of the associated listed items.

According to the various embodiments described herein, robotic process automation (RPA) is used for automating various business processes. As described, RPA is a form of process automation using software robots to automate repetitive and/or labor-intensive tasks to improve productivity of human operators. In an RPA-enabled system, workflows comprising one or more activities are created and then executed by robots, either in an attended mode (e.g., triggered by human agents to assist in completing processes) or in unattended mode (e.g., working independently, such as with back-end system tasks).

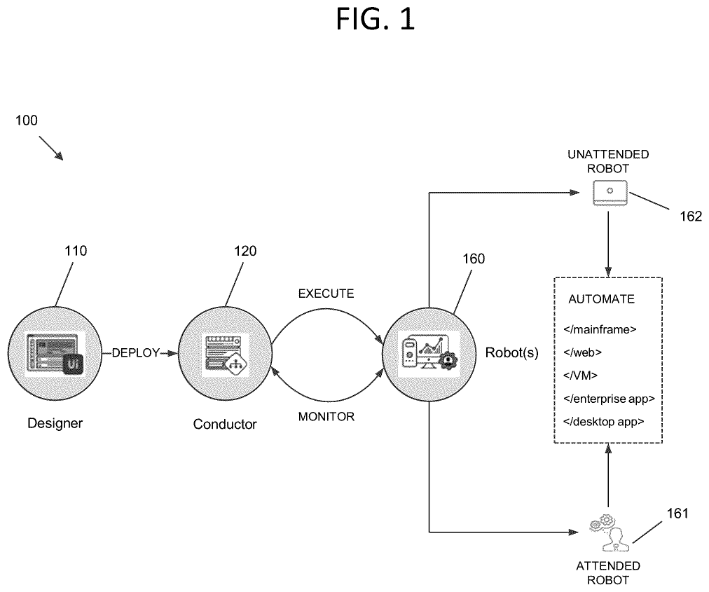

Exemplary RPA System Architecture. FIG. 1 is an architectural diagram of an RPA system 100 according to an illustrative embodiment. As shown, RPA system 100 includes designer 110 to allow a developer to design automation processes using workflows. More specifically, designer 110 facilitates the development and deployment of workflows and robots for performing activities in the workflows. Designer 110 may provide a solution for application integration, as well as automating third-party applications, administrative Information Technology (IT) tasks, and business processes for contact center operations. One commercial example of an embodiment of designer 110 is UiPath Studio™.

In designing the automation of rule-based processes, the developer controls the execution order and the relationship between a custom set of steps developed in a workflow, defined herein as “activities.” Each activity may include an action, such as clicking a button, reading a file, writing to a log panel, etc. In some embodiments, workflows may be nested or embedded.

Some types of workflows may include, but are not limited to, sequences, flowcharts, Finite State Machines (FSMs), and/or global exception handlers. Sequences may be particularly suitable for linear processes, enabling flow from one activity to another without cluttering a workflow. Flowcharts may be particularly suitable to more complex business logic, enabling integration of decisions and connection of activities in a more diverse manner through multiple branching logic operators. FSMs may be particularly suitable for large workflows. FSMs may use a finite number of states in their execution, which are triggered by a condition (i.e., transition) or an activity. Global exception handlers may be particularly suitable for determining workflow behavior when encountering an execution error and for debugging processes.

Once a workflow is developed in designer 110, execution of business processes is orchestrated by conductor 120, which orchestrates one or more robots 160 that execute the workflows developed in designer 110. One commercial example of an embodiment of conductor 120 is UiPath Orchestrator™. Conductor 120 facilitates management of the creation, monitoring, and deployment of resources in an RPA environment. In one example, conductor 120 is a web application. Conductor 120 may also function as an integration point with third-party solutions and applications.

Conductor 120 may manage a fleet of robots 160 by connecting and executing robots 160 from a centralized point. Conductor 120 may have various capabilities including, but not limited to, provisioning, deployment, configuration, queueing, monitoring, logging, and/or providing interconnectivity. Provisioning may include creating and maintenance of connections between robots 160 and conductor 120 (e.g., a web application). Deployment may include assuring the correct delivery of package versions to assigned robots 160 for execution. Configuration may include maintenance and delivery of robot environments and process configurations. Queueing may include providing management of queues and queue items. Monitoring may include keeping track of robot identification data and maintaining user permissions. Logging may include storing and indexing logs to a database (e.g., an SQL database) and/or another storage mechanism (e.g., ElasticSearch®, which provides the ability to store and quickly query large datasets). Conductor 120 may provide interconnectivity by acting as the centralized point of communication for third-party solutions and/or applications.

Robots 160 are execution agents that run workflows built in designer 110. One commercial example of some embodiments of robots 160 is UiPath Robots™. Types of robots 160 may include, but are not limited to, attended robots 161 and unattended robots 162. Attended robots 161 are triggered by a user or user events and operate alongside a human user, e.g., a contact center agent, on the same computing system. Attended robots 161 may help the human user accomplish various tasks and may be triggered directly by the human user and/or by user events. In the case of attended robots, conductor 120 may provide centralized process deployment and a logging medium. In certain embodiments, attended robots 161 can only be started from a “robot tray” or from a command prompt in a web application. Unattended robots 162 operate in an unattended mode in virtual environments and can be used for automating many processes, e.g., for high-volume, back-end processes and so on. Unattended robots 162 may be responsible for remote execution, monitoring, scheduling, and providing support for work queues. Both attended and unattended robots may automate various systems and applications including, but not limited to, mainframes, web applications, VMs, enterprise applications (e.g., those produced by SAP®, SalesForce®, Oracle®, etc.), and computing system applications (e.g., desktop and laptop applications, mobile device applications, wearable computer applications, etc.).

In some embodiments, robots 160 install the Microsoft Windows® Service Control Manager (SCM)-managed service by default. As a result, such robots 160 can open interactive Windows® sessions under the local system account and have the rights of a Windows® service. In some embodiments, robots 160 can be installed in a user mode with the same rights as the user under which a given robot 160 has been installed.

Robots 160 in some embodiments are split into several components, each being dedicated to a particular task. Robot components in some embodiments include, but are not limited to, SCM-managed robot services, user mode robot services, executors, agents, and command line. SCM-managed robot services manage and monitor Windows® sessions and act as a proxy between conductor 120 and the execution hosts (i.e., the computing systems on which robots 160 are executed). These services are trusted with and manage the credentials for robots 160. A console application is launched by the SCM under the local system. User mode robot services in some embodiments manage and monitor Windows® sessions and act as a proxy between conductor 120 and the execution hosts. User mode robot services may be trusted with and manage the credentials for robots 160. A Windows® application may automatically be launched if the SCM-managed robot service is not installed. Executors may run given jobs under a Windows® session (e.g., they may execute workflows) and they may be aware of per-monitor dots per inch (DPI) settings.

Agents may be Windows® Presentation Foundation (WPF) applications that display the available jobs in the system tray window. Agents may be a client of the service. Agents may request to start or stop jobs and change settings. Command line is a client of the service and is a console application that can request to start jobs and waits for their output. Splitting robot components can help developers, support users, and enable computing systems to more easily run, identify, and track what each robot component is executing. For example, special behaviors may be configured per robot component, such as setting up different firewall rules for the executor and the service. As a further example, an executor may be aware of DPI settings per monitor in some embodiments and, as a result, workflows may be executed at any DPI regardless of the configuration of the computing system on which they were created.

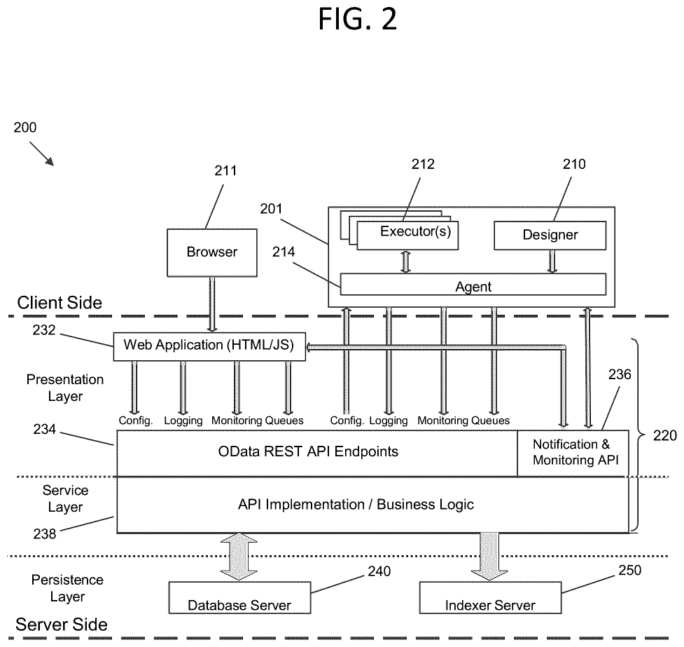

FIG. 2 shows RPA system 200 according to an illustrative embodiment. RPA system 200 may be, or may be part of, RPA system 100 of FIG. 1. It should be noted that the “client side”, the “server side”, or both, may include any desired number of computing systems without deviating from the scope of the invention.

As shown on the client side in this embodiment, computing system 201 includes one or more executors 212, agent 214, and designer 210. In other embodiments, designer 210 may not be running on the same computing system 201. An executor 212 (which may be a robot component as described above) runs a process and, in some embodiments, multiple business processes may run simultaneously. In this example, agent 214 (e.g., a Windows® service) is the single point of contact for managing executors 212.

In some embodiments, a robot represents an association between a machine name and a username. A robot may manage multiple executors at the same time. On computing systems that support multiple interactive sessions running simultaneously (e.g., Windows® Server 2012), multiple robots may be running at the same time (e.g., a high density (HD) environment), each in a separate Windows® session using a unique username.

Agent 214 is also responsible for sending the status of the robot (e.g., periodically sending a “heartbeat” message indicating that the robot is still functioning) and downloading the required version of the package to be executed. The communication between agent 214 and conductor 220 is initiated by agent 214 in some embodiments. In the example of a notification scenario, agent 214 may open a WebSocket channel that is later used by conductor 220 to send commands to the robot (e.g., start, stop, etc.).

As shown on the server side in this embodiment, a presentation layer comprises web application 232, Open Data Protocol (OData) Representative State Transfer (REST) Application Programming Interface (API) endpoints 234 and notification and monitoring API 236. A service layer on the server side includes API implementation/business logic 238. A persistence layer on the server side includes database server 240 and indexer server 250. Conductor 220 includes web application 232, OData REST API endpoints 234, notification and monitoring API 236, and API implementation/business logic 238.

In various embodiments, most actions that a user performs in the interface of conductor 220 (e.g., via browser 211) are performed by calling various APIs. Such actions may include, but are not limited to, starting jobs on robots, adding/removing data in queues, scheduling jobs to run unattended, and so on. Web application 232 is the visual layer of the server platform. In this embodiment, web application 232 uses Hypertext Markup Language (HTML) and JavaScript (JS). However, any desired markup languages, script languages, or any other formats may be used without deviating from the scope of the invention. The user interacts with web pages from web application 232 via browser 211 in this embodiment in order to perform various actions to control conductor 220. For instance, the user may create robot groups, assign packages to the robots, analyze logs per robot and/or per process, start and stop robots, etc.

In addition to web application 232, conductor 220 also includes a service layer that exposes OData REST API endpoints 234 (or other endpoints may be implemented without deviating from the scope of the invention). The REST API is consumed by both web application 232 and agent 214. Agent 214 is the supervisor of one or more robots on the client computer in this exemplary configuration.

The REST API in this embodiment covers configuration, logging, monitoring, and queueing functionality. The configuration REST endpoints may be used to define and configure application users, permissions, robots, assets, releases, and environments in some embodiments. Logging REST endpoints may be useful for logging different information, such as errors, explicit messages sent by the robots, and other environment-specific information, for example. Deployment REST endpoints may be used by the robots to query the package version that should be executed if the start job command is used in conductor 220. Queueing REST endpoints may be responsible for queues and queue item management, such as adding data to a queue, obtaining a transaction from the queue, setting the status of a transaction, etc. Monitoring REST endpoints monitor web application 232 and agent 214. Notification and monitoring API 236 may be REST endpoints that are used for registering agent 214, delivering configuration settings to agent 214, and for sending/receiving notifications from the server and agent 214. Notification and monitoring API 236 may also use WebSocket communication in some embodiments.

The persistence layer on the server side includes a pair of servers in this illustrative embodiment—database server 240 (e.g., a SQL server) and indexer server 250. Database server 240 in this embodiment stores the configurations of the robots, robot groups, associated processes, users, roles, schedules, etc. This information is managed through web application 232 in some embodiments. Database server 240 may also manage queues and queue items. In some embodiments, database server 240 may store messages logged by the robots (in addition to or in lieu of indexer server 250). Indexer server 250, which is optional in some embodiments, stores and indexes the information logged by the robots. In certain embodiments, indexer server 250 may be disabled through configuration settings. In some embodiments, indexer server 250 uses ElasticSearch®, which is an open source project full-text search engine. Messages logged by robots (e.g., using activities like log message or write line) may be sent through the logging REST endpoint(s) to indexer server 250, where they are indexed for future utilization.

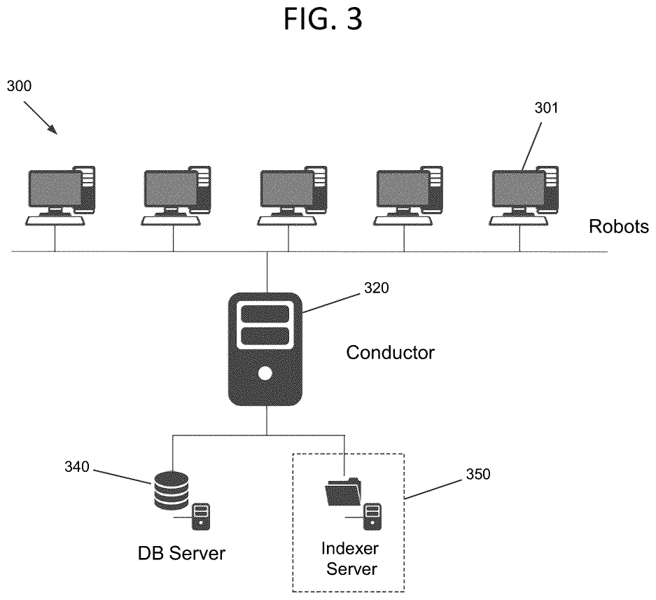

FIG. 3 is an architectural diagram illustrating a simplified deployment example of RPA system 300 according to an embodiment. In some embodiments, RPA system 300 may be, or may include RPA systems 100 and/or 200 of FIGS. 1 and 2, respectively. RPA system 300 includes multiple client computing systems 301 running robots. Computing systems 301 are able to communicate with a conductor computing system 320 via a web application running thereon. Conductor computing system 320, in turn, communicates with database server 340 and an optional indexer server 350. With respect to FIGS. 2 and 3, it should be noted that while a web application is used in these embodiments, any suitable client/server software may be used without deviating from the scope of the invention. For instance, the conductor may run a server-side application that communicates with non-web-based client software applications on the client computing systems.

Existing RPA workflow design applications may provide some assistance to a user in the form of a “favorites” or “recently used activity” tab on a user interface dashboard. The user would then be able to select an activity from these lists in a more expedient manner to build an RPA workflow. However, such features do not add any intelligence to the activity selection process, so the workflow design process is still a manual, labor-intensive, time-consuming effort on the part of the user to choose appropriate activities in an ordered sequence.

According to various embodiments described herein, an intelligent workflow design solution assists a user (e.g., developer of RPA workflows) by automatically and intelligently recommending suggested activities for use in building sequences of activities in a workflow. More specifically, the solution utilizes a predictive learning model (e.g., based on an artificial intelligence implementation) to customize and personalize the workflow design process for a user. As a user is developing an RPA workflow, the activities selected by the user are monitored in real-time (or substantially in real-time) and one or more recommended activities are identified as candidate activities for the user to consider for use as the next activity in the sequence of activities for the workflow. The identification and generation of the recommended activities is also performed in real-time (or substantially in real-time) using a predictive learning model.

The process is further personalized for the user as the predictive learning model is trained and re-trained based on actual selections that are made by the user, e.g., based on whether the user is selecting from the recommended activities or not. The identification of recommended activities can be based on a number of considerations. For example, personalization may take into account user-specific patterns from past activity selections by the user (e.g., user preferences, coding style of the user, etc.). Customization can be achieved through intelligence-based filtering of activities that are most relevant (e.g., most popular, most commonly used) for the workflow being designed, and so on.

According to one or more embodiments, the system may include a design environment with a user interface that allows a user to easily drag-and-drop the recommended activities in order to expediently build a workflow in an efficient and effective manner. For example, after an activity is dropped into the workflow design window of the user interface, an activity suggestion tab on the user interface would be automatically updated with the next set of recommendations identified by the predictive learning model. Initially, the system may start by recommending activities based on popularity filtering, e.g., the most commonly used activities (by all developers). With time, the predictive learning model leverages artificial intelligence functionality to train and adapt the model in order to generate recommendations that are relevant and that are more tailored to the style and preferences of the user.

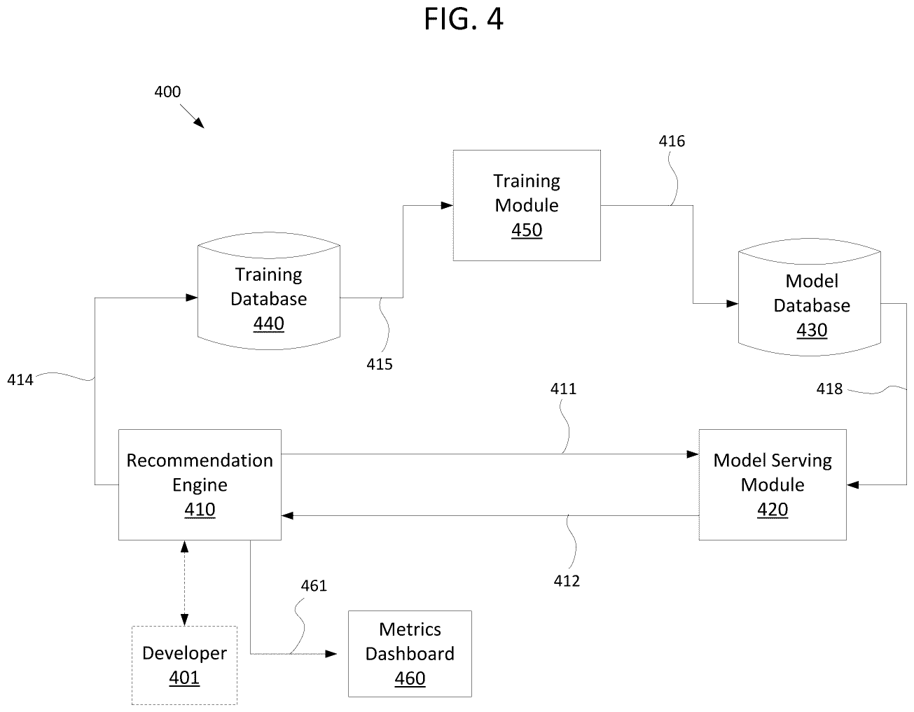

FIG. 4 shows system 400 for implementing the features of intelligent workflow design in accordance with an embodiment. Referring back to FIGS. 1 and 2, for example, some or all of the elements in system 400 could be implemented as part of a configuration in a computing system used for designer 110 (FIG. 1) and/or designer 210 (FIG. 2).

As shown in FIG. 4, system 400 includes model serving module 420, model database 430, recommendation engine 410, training database 440, re-training module 450, and a metrics dashboard 460. In one embodiment, recommendation engine 410 may be incorporated in designer 110 or 210 (FIGS. 1 and 2), while the other elements of system 400 may be configured in a separate computer system or systems that interoperate with designer 110 or 210. A developer (user) 401 is shown as interfacing (e.g., directly or indirectly) through the system with recommendation engine 410. Such a configuration is intended to be exemplary only and not limiting in any manner.

In an RPA workflow design environment according to an embodiment, recommendation engine 410 is configured to continuously monitor the activities that are being selected by the developer (user) 401 in the course of building RPA-enabled workflows and collecting data that is indicative of the activities that are being used by the developer (user). Such monitoring may be done on a continuous basis, a periodic basis, a scheduled basis, or any combination or variant thereof. As shown via workflow 411, recommendation engine 410 is further configured to communicate or otherwise share the data regarding the current activity (activities) being used by the developer (user) 401 with a machine learning model, which would be done via model serving module 420 in this example. Recommendation engine 410 is also configured to receive recommended/suggested activities from model serving module 420 as shown by workflow 412 and facilitate the sharing of the recommendations/suggestions with the developer (user) 401, e.g., via a user interface operated by developer (user) 401. In one example, the user interface (not shown) could be configured to share a view that includes a recommendations/suggestions tab.

Each subsequent activity that is selected and used by developer (user) 401 may be further captured and stored in training database 440 as shown by workflow 414 for use in a machine learning-based training/re-training model, which will be described in further detail below. In system 400, re-training module 450 would be used to facilitate the initiation and operation of the machine learning-based training/re-training model using the data and information stored in training database 440 as shown by workflow 415. For example, training and subsequent re-training may be accomplished using user-specific data as training data (e.g., data stored in training database 440 regarding the activities used by the developer in developing workflows). The output of the training/re-training model activities would be a re-trained model that is personalized for the developer (user) based on the user-specific data. The retrained model is stored in model database 430 as shown by workflow 416. Information stored in model database 430 may also include parameters associated with the model, e.g., information for model identification, model version, model status, and so on. The re-trained model could then be used as an updated model (e.g., the latest model version). For example, the re-trained model stored in model database 430 could be retrieved by model serving module 420 as shown by workflow 418 and provided for subsequent use by recommendation engine 410 as described above. In general, and as will be described in further detail below, model serving module 420 is configured to load the current (latest) model from model database 430, which is then used for predicting, e.g., to generate recommendations. It is contemplated that the process carried out by system 400 would continue as the developer (user) continues to develop RPA-enabled workflows. In this manner, machine learning will continue to update and optimize the selection, suggestion, and training/re-training functions, which will enhance the productivity of the workflow development function, thereby improving the efficiency and effectiveness of the developer (user) responsible for such workflow development.

According to another aspect, recommendation engine 410 may be configured in some embodiments to generate and update metrics data, which is provided to metrics dashboard 460 as shown by workflow 461. For example, recommendation engine 410 can be configured to track certain metrics associated with the activities used by the developer in building a workflow. Such information may be useful for comparing the efficiency of a developer (user) selecting a recommended activity instead of one that is not recommended by the predictive learning model (e.g., the developer may choose instead to use another activity such as one that is simply bookmarked in a “favorites” tab, etc.). Metrics may include data or other information that quantifies or tracks parameters such as number of mouse clicks, amount of text input by the developer to select an activity, the amount of time to complete the task of adding a respective activity, the amount of time to complete the design of a workflow with all the activities, and so on. Metrics can also help a user in evaluating the performance of the model based on the aforementioned data, information and findings. These examples are only meant to be illustrative and not limiting in any manner.

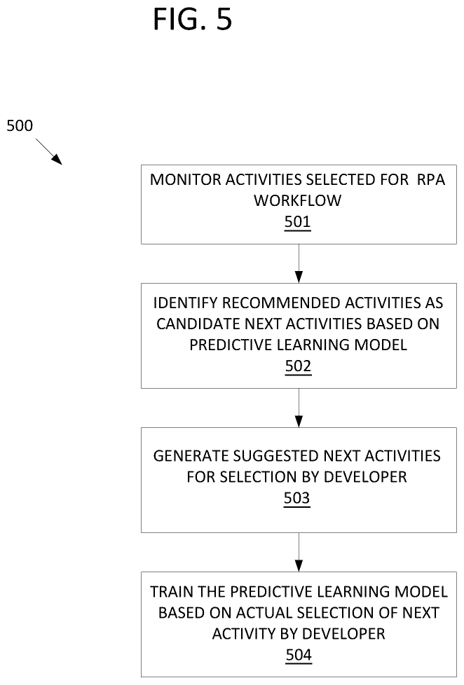

FIG. 5 shows a method 500 for implementing the features of intelligent RPA workflow design in accordance with one or more embodiments. More specifically, method 500 can be used in the development of an RPA workflow that comprises a sequence of activities. At step 501, activities selected by the developer are monitored, e.g., by recommendation engine 410 in system 400 of FIG. 4. In one embodiment, monitoring may be performed in a continuous manner and, in one example, is performed substantially in real-time as the developer is designing the RPA workflow.

At step 502, one or more recommended activities are identified as candidate next activities for the sequence of activities based on a predictive learning model. Referring back to FIG. 4, the one or more recommended activities are identified using model serving module 420. More specifically, model serving module 420 predicts the next set of activities that are relevant to the RPA workflow, at that point of time. These candidate next activities are therefore based on the current state, e.g., current set of activities. In one embodiment, and as will be described in further detail below, identifying the one or more recommended activities as candidate next activities comprises using intelligence-based filtering to identify commonly used activities relevant to the RPA workflow (e.g., activities that are most relevant, most commonly used, most popular choices by other developers, etc.).

At step 503, the suggested next activities (e.g., for use as the next activity in the sequence) are generated for selection by the developer. In one embodiment, generating suggested activities may be performed substantially in real-time during development of the RPA workflow. Referring back to FIG. 4, recommendation engine 410 generates and presents the suggested next activities to user 401. In one example, an activity suggestions or recommendations tab in a user interface (not shown) may be used to present the recommendations generated by recommendation engine 410 to user 401.

According to various embodiments, the suggested next activities generated by recommendation engine 410 may include one or more of the candidate next activities predicted by model serving module 420. In some embodiments, the suggested next activities are generated from recommendation engine 410 by: (i) evaluating the candidate next activities (predicted by the model serving module 420) in the context of a user-specific pattern corresponding to past selections of activities; and (ii) based on that evaluation, personalizing the suggested next activities (e.g., based on user-specific considerations, removing one or more of the candidate next activities, adding other activities, and/or various combinations thereof).

For example, personalization of the suggested next activities may take into account the coding style of the developer (user), past usage patterns and/or activity preferences of the developer (user), confidence thresholds (e.g., only suggesting activities having a confidence rating above a certain threshold level), and so on. In particular, recommendation engine 410 possesses information about the developer's style and patterns of use. As such, recommendation engine 410 can evaluate and assess the predicted activities identified and generated by the model serving module 420 in the context of the particular developer's pattern and style. From that evaluation and assessment, recommendation engine 410 may further modify the set of predicted activities (e.g., the candidate next activities generated by model serving module 420) before presentation to the developer (user) for selection. For example, based on user-specific considerations, certain of the candidate next activities may be removed, other activities may be added, and/or various combinations thereof.

In this manner, generation of suggested activities can be based on: (i) a global usage and recommendation pattern (e.g., candidate next activities identified by filtering for common usage, most popular, most relevant, etc.); and (ii) user-specific personalization. In one or more embodiments, the global usage and recommendation pattern may take into consideration the activity selections by all developers (users) and assigning confidence ratings based on the number of users selecting a particular activity as the next activity in a sequence of an RPA workflow, e.g., 10 users selected Activity X to follow in sequence after Activity A, 25 users selected Activity B to follow in sequence after Activity A, and so on. By taking the global population of developers (users) into account, the model is trained to produce candidate next activities (recommendations) based on global usage patterns. Personalization may then be applied (by the recommendation engine 410), as described above, to further customize/tailor the activity set that was predicted based on global usage.

In a simplified example, assume model serving module 420 predicts five (5) activities as candidate next activities, with the five (5) activities having confidence ratings of 100%, 90%, 80%, 70% and 60%. Assume further that recommendation engine 410 has a selection criteria in which activities having a confidence rating below 70% are to be eliminated. As such, in the course of evaluating/assessing the five (5) activities, recommendation engine 410 will remove/drop the activity having a confidence rating of 60% from the set and may add one or more other activities (not already in the set predicted by model serving module 420). For example, recommendation engine 410 may generate a set of suggested next activities, for selection by the developer (user), which includes the four (4) predicted activities having a confidence rating at or above 70% from the global usage set and an additional one (1) activity that was selected by recommendation engine 410 based on user-specific considerations of the specific developer (user) being served. This simplified example is meant to be illustrative only and not limiting in any manner.

At step 504, the predictive learning model is trained based on an actual selection, by the developer, of a next activity for use in the sequence. In one embodiment, training the predictive learning model may comprise storing an inventory of the commonly used activities relevant to the RPA workflow, storing an inventory of the past selections of activities by the developer, and updating the predictive learning model based on (i) the commonly used activities, (ii) the past selections, and (iii) the current activities being selected by the developer (e.g., those being monitored in real-time). Referring to FIG. 4, training module 450 and training database 440 are used for training/re-training the model. Various implementations for the predictive learning model are contemplated by the teachings herein. For example, the learning model may be an artificial intelligence model that uses a filtering model (e.g., content filtering), a deep learning model, a ranking model, and various other models that can be suitably used for the embodiments described herein.

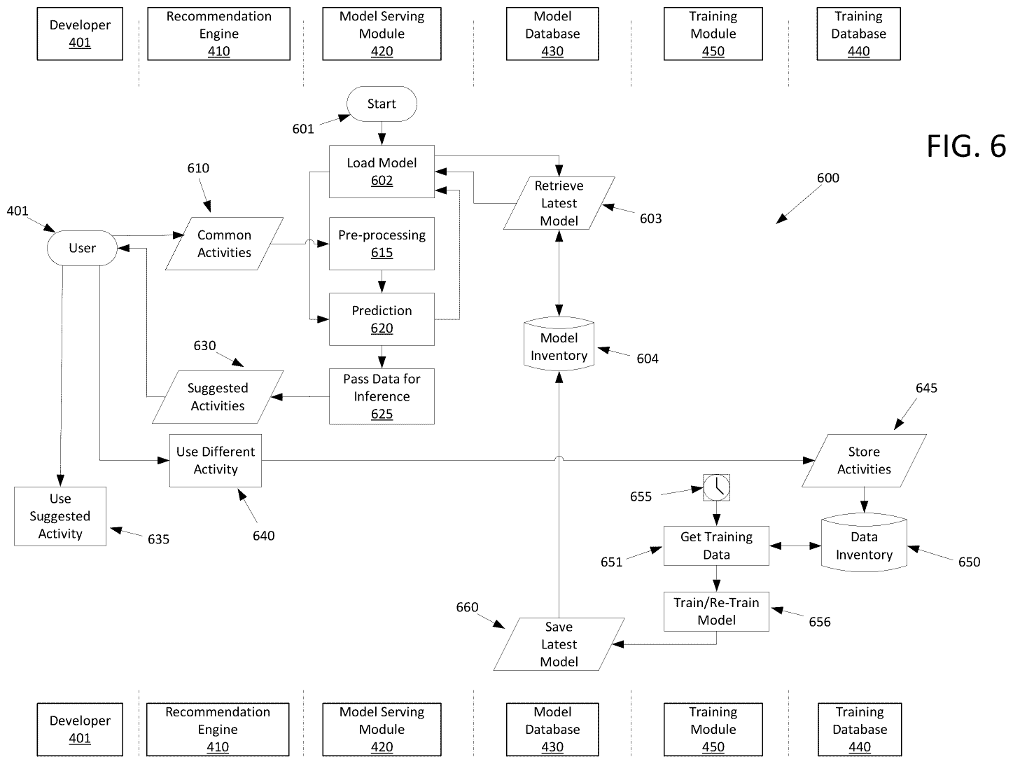

FIG. 6 is a more detailed flow diagram illustrating workflow 600 for implementing the features associated with generating activity recommendations for developing an RPA workflow, in accordance with one or more embodiments. The elements of system 400 (from FIG. 4) are shown at the top and bottom of FIG. 6 for reference purposes to understand the correspondence with the detailed workflow activities. The workflows will be described with reference to the applicable elements from system 400.

Workflow 600 is initiated at step 601, which can occur, in one example, when the developer (user) 401 initializes the system being used for developing RPA workflows, e.g., designer 110 (FIG. 1) or designer 201 (FIG. 2). As shown in block 602, the latest model (e.g., current model) is loaded into the model serving module 420. More specifically, model inventory 604 is stored in model database 430 and includes the latest model, which is retrieved as shown in block 603.

At this point in the workflow development, developer (user) 401 starts developing an RPA workflow, which requires the selection of a sequence of activities. In this example, to start the process, user 401 is selecting common activities 610 and the selection of these activities is being monitored by the recommendation engine. The monitored activity selection is provided from recommendation engine 410 to model serving module 420 for pre-processing as shown in block 615 and prediction as shown in block 620. As shown, the latest model (which was loaded in block 602) is used in the prediction process for generating one or more recommended activities for consideration by user 401. More specifically, the predictive algorithms employed in the predictive (machine) learning model identify recommendations for candidate next activities 630 that are passed to recommendation engine 410 as shown by block 625. In an embodiment, data resulting from the execution of the machine learning model is then passed for inference, e.g., generating a conclusive decision from post-processing of the results from the machine learning model. Aspects of the predictive learning model for identifying recommended activities (possible activities that can be considered for selection by user 401) will be described in further detail below.

In one embodiment, the recommendations in the form of suggested activities 630 generated by recommendation engine 410 (e.g., and personalized as described above) may be presented to user 401 via a user interface, e.g., in the application program running designer 110 (FIG. 1) or designer 210 (FIG. 2). User 401 then chooses a next activity in the sequence. In the scenario where user 401 chooses one of the suggested activities (as shown in block 635), the above-described process is then repeated until the workflow is completed, e.g., when the sequence of activities is completed for the RPA workflow.

In the scenario where user 401 does not choose any of the suggested activities recommended by the predictive learning model, but instead chooses a different activity (as shown in block 640), the different selected activity is captured and stored as shown in block 645 for use in training the model. More specifically, the non-recommended activities selected by user 401 are maintained in a data inventory 650 that is stored in training database 440.

In one embodiment, training (and/or re-training) the model can occur on a scheduled basis as shown by timer 655. Alternatively, training can be triggered by a condition or set of conditions. In either case, training is executed in the training module 450 using the latest stored data in training database 440 as the training data. More specifically, as shown, training data is retrieved (as shown in block 651) from data inventory 650, which includes the non-recommended activities selected by the user. The model is trained/re-trained as shown in block 656, saved as the latest model in block 660 and the model inventory 604 (stored in model database 430) is then updated with the latest re-trained model.

In one embodiment, the re-trained model is updated and stored along with its metadata-like version, so that the latest model can be properly loaded in block 602 when appropriate. For example, when the training process is initiated, training data is collected from data inventory 650 (stored in training database 440). In some embodiments, the training process can be of different types including, but not limited to: (i) transfer-based learning, which takes the previous best model and performs additional training (e.g., re-training) with the new data from data inventory 650 to create an updated model; and/or (ii) “fresh” training, which uses all the data from data inventory 650 and creates a “fresh” model. Based on the performance of these two models (e.g., the re-trained/updated model and/or the “fresh” model), along with respective comparison to the current model already in use (e.g., the latest model stored in model inventory 604), the current, latest model may or may not be replaced. Capturing and storing metadata (e.g., additional information about the model, such as version, date, etc.) can be useful for indexing and retrieval purposes. For example, if the new trained/re-trained model performs better than the current model in use, then the new model can be pushed into model database 430 and its version (from metadata) can be updated. Thereafter, retrieving and loading the latest model (via blocks 602 and 603) would include checking for any newly available model, e.g., by checking for a later version number, and so on. In sum, the stored metadata assists with retrieval of the latest model for use.

In operation, the predictive learning model for identifying and generating recommendations for workflow activities will be described in the context of two illustrative examples, which are not intended to be limiting in any manner. In a first example, the predictive learning model according to an embodiment generates recommended activities using intelligence-based filtering to identify commonly used activities relevant to the RPA workflow. In a scenario in which a developer (user) is designing a workflow that involves a spreadsheet application (e.g., Microsoft Excel-based workflow), the developer would start creating the workflow by opening an “Excel Application Scope” activity. Recommended activities to be suggested to the developer should include common activities, e.g. those that are most relevant, most popular, most commonly used, e.g., activities such as “Read Row”, “Write Row”, “Read Column”, “Write Column”, etc. Once a developer selects (e.g., places) the “Write Row” activity into his workspace, the next intelligence-filtered suggestion(s) should then be identified and generated, e.g., use of “Write Row” should identify and generate activities such as “Save Workbook”, “Close Workbook”, etc. as suggested activities for the next activity in the sequence. Once the developer closes the workbook using a “Close Workbook” activity, for example, the next set of recommendations (based on the previously used activity “Close Workbook”) should include suggested activities such as, for example, “Message Box” activity, “Log Message” activity, etc. This simplified example demonstrates the use of intelligence-based filtering to identify and generate the most relevant activities for the particular RPA workflow being developed, e.g., based on most relevant, most common/popular used activities, and so on.

In a second example, the predictive learning model according to an embodiment generates recommended activities based on a specific pattern of usage by a developer, e.g., past usage history (past selections), which likely will correlate with a coding style and preferences of the developer (user). Consider a scenario in which a developer has a particular coding style (preferences, etc.) for selecting activities when opening a browser. For example, the developer opens a browser, takes a screenshot, and then sends an email. According to an embodiment, once the developer selects the “Open Browser” activity for the workflow, the recommendation engine will automatically suggest the recommended activity of “Take Screenshot” activity, and once selected by the developer, the next recommended activity to be automatically provided should be a “Send Outlook Mail Message” activity. As described, the intent is to monitor the activities selected by a developer for automated tasks and learn from those usage patterns and historical behavior.

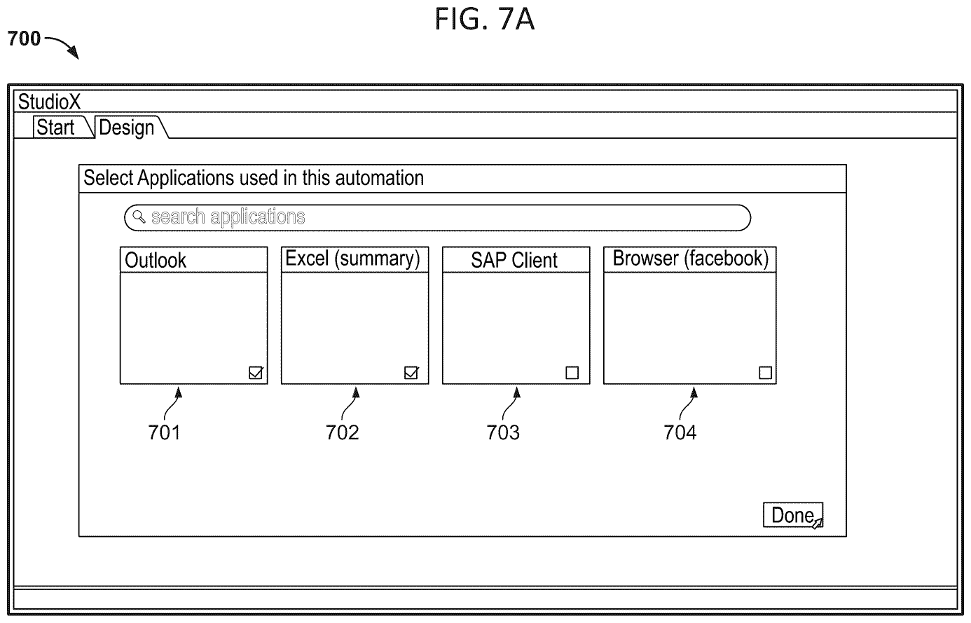

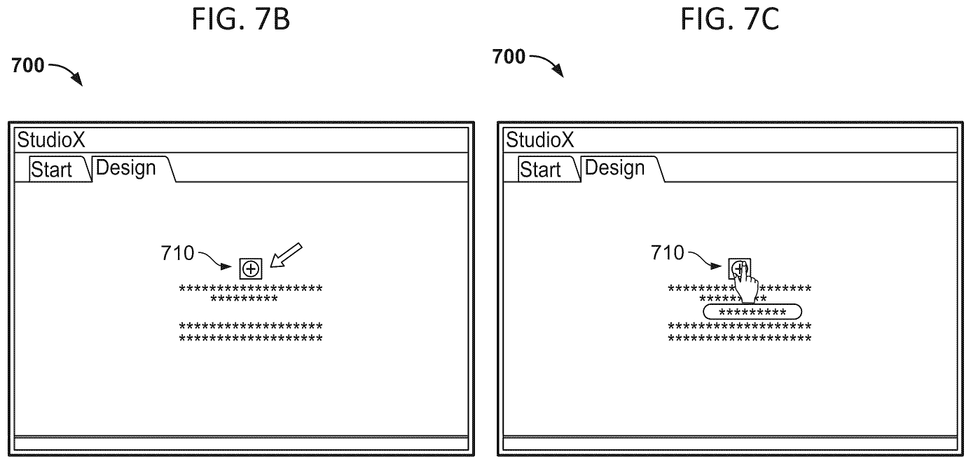

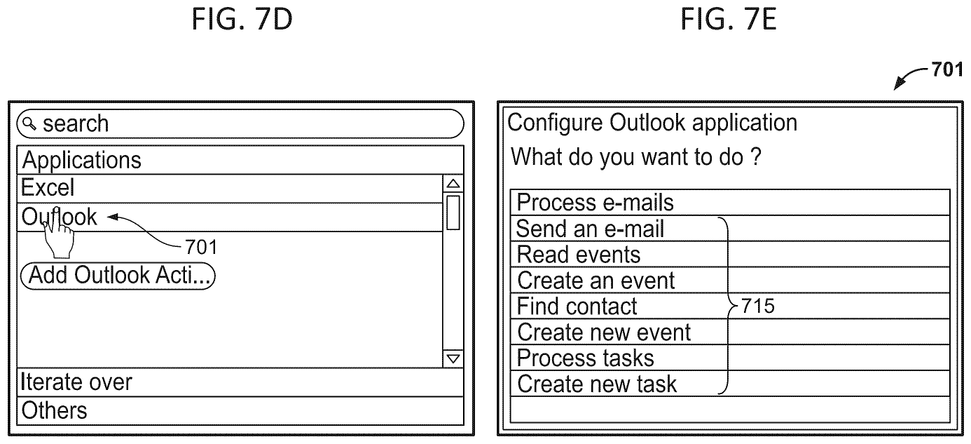

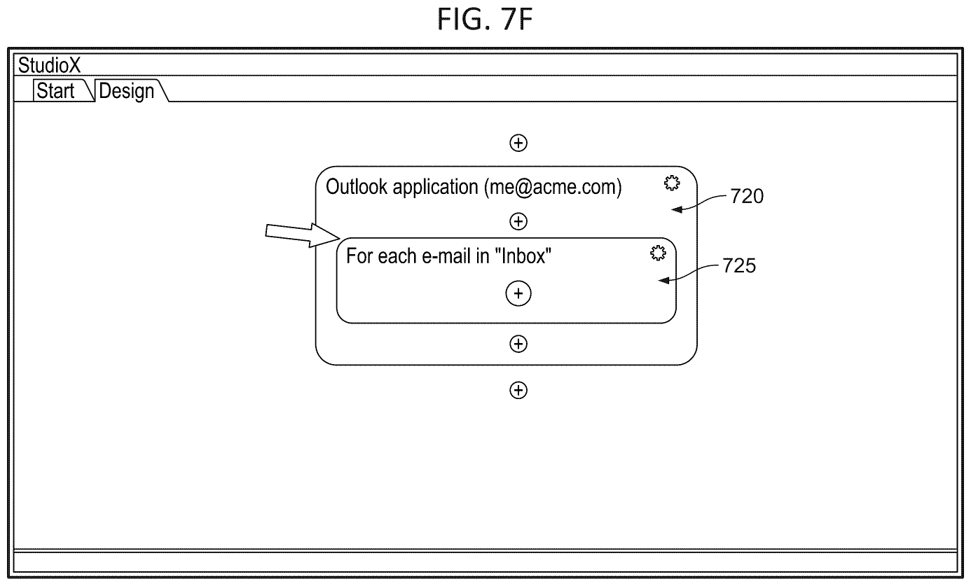

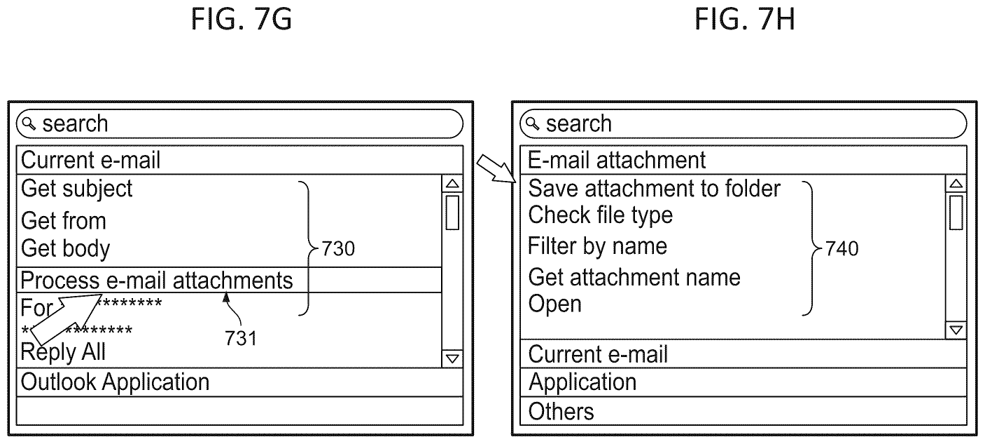

FIGS. 7A through 7H show various screenshots illustrating a particular use case developing RPA-enabled workflows in accordance with one or more embodiments. In this exemplary case, the predictive learning model will be identifying and generating recommendations (for next-in-line activities for a sequence) based on monitoring current design choices (current selection of activities) as well as pattern-based user preferences. As shown in FIG. 7A, assume the system, e.g., designer 110 or 201 (FIG. 1 or 2), allows a user to select one or more applications on the automation task template 700 from a list of applications such as Outlook 701, Excel 702, SAP 703, and a browser application 704.

As shown in FIGS. 7B and 7C, the user can start creating the workflow from template 700 and adding activities (e.g., steps) by clicking on the “+” button 710. As shown in FIG. 7D, the user selects the Outlook application 701 and, referring to FIG. 7E, is then presented with a list of suggested activities 715 that are considered relevant to the user. Initially, the list of suggested activities 715 will be related to the application selected by the user (e.g., Outlook application 701 in this example). As shown in FIG. 7F, the predictive learning model of the system recommends suggested activities to the user at every step, e.g., whenever the user clicks on the “+” button to add an activity, another recommendation is provided for suggested activities that would be relevant as a next step in the sequence for the workflow. For example, as shown in FIG. 7F, the first selection 720 made by the user then triggers a next recommendation for a suggested activity 725, in this case a “For each e-mail in Inbox” activity. As shown in FIG. 7G, the next recommendation for suggested activities 730 were triggered based on the prior activity selection. In this case, suggested activities 730 triggered by selecting “Current e-mail” include “”Get subject“, “Get from”, “Get body”, “Process e-mail attachments”, etc. By selecting the “Process e-mail attachments” activity 731 in FIG. 7G, the user is then presented with the next recommendation for suggested steps 740 as shown in FIG. 7H, e.g., “Save attachment to folder”, “Check file type”, “Filter by name”, “Get attachment name”, and “Open”. The process of generating recommended suggested activities as next steps for the workflow sequence continues until the user has completed the workflow. In this use case, the initial activity selected related to email and, as such, subsequent recommendations were related to email.

According to an aspect of the embodiments described herein, the predictive learning model leverages artificial intelligence and learning of user preferences to identify and generate recommendations for suggested next steps as the workflow design progresses. In this way, the system and method according to the embodiments can greatly simplify the development of workflows, both in terms of time and effort, especially when the workflows may be very complex given the number of activities. It is contemplated that various implementations can be utilized for implementing the artificial intelligence model for the predictive aspects of the model.

By way of example and not limitation, one such model may utilize popularity filtering, in which recommendations are typically based on the popularity of the content, which would be the popularity of activities for workflows. With this type of model, recommendations will be driven toward the most popular activity (or activities) among all users, e.g., the most popular activity that is typically selected to follow the prior activity selection made by the particular user designing his or her workflow. With this approach the recommendations will be same for every user in the initial stages and until personalization occurs through the learning process.

In another example, a model may utilize content filtering, which is an extension of popularity filtering in certain aspects. In this model, recommendations are identified based on popularity as described above in addition to the user's style (e.g., preferences) and his or her interactions with the system (e.g., designer 110). In this model, customization and personalization can occur based on learning the traits of the particular user, while also taking popularity considerations into account.

A deep learning model and a ranking-based model (e.g., a learn to rank (LTR) model that assigns ranks to a list of items such as workflow activities) are other examples that can be suitably used for the predictive model. These examples are meant to be illustrative only and not limiting in any manner.

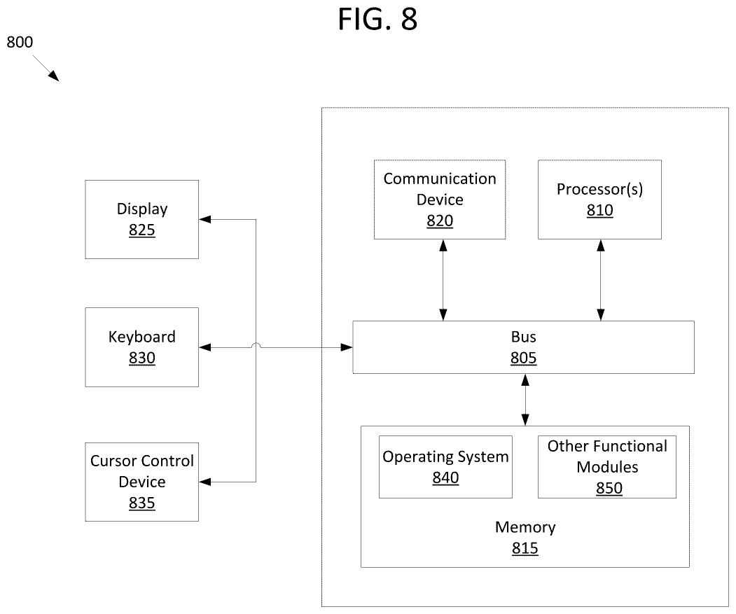

FIG. 8 is a block diagram illustrating a computing system 800 configured to execute the method described in reference to FIG. 5, according to an embodiment. In some embodiments, computing system 800 may be one or more of the computing systems depicted and/or described herein. Computing system 800 includes a bus 805 or other communication mechanism for communicating information, and processor(s) 810 coupled to bus 805 for processing information. Processor(s) 810 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 810 may also have multiple processing cores, and at least some of the cores may be configured to perform specific functions. Multi-parallel processing may be used in some embodiments.

Computing system 800 further includes a memory 815 for storing information and instructions to be executed by processor(s) 610. Memory 815 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 810 and may include volatile media, non-volatile media, or both. The media may also be removable, non-removable, or both.

Additionally, computing system 800 includes a communication device 820, such as a transceiver, to provide access to a communications network via a wireless and/or wired connection according to any currently existing or future-implemented communications standard and/or protocol.

Processor(s) 810 are further coupled via bus 805 to a display 825 that is suitable for displaying information to a user. Display 825 may also be configured as a touch display and/or any suitable haptic I/O device.

A keyboard 830 and a cursor control device 835, such as a computer mouse, a touchpad, etc., are further coupled to bus 805 to enable a user to interface with computing system. However, in certain embodiments, a physical keyboard and mouse may not be present, and the user may interact with the device solely through display 825 and/or a touchpad (not shown). Any type and combination of input devices may be used as a matter of design choice. In certain embodiments, no physical input device and/or display is present. For instance, the user may interact with computing system 800 remotely via another computing system in communication therewith, or computing system 800 may operate autonomously.

Memory 815 stores software modules that provide functionality when executed by processor(s) 810. The modules include an operating system 840 for computing system 800 and one or more additional functional modules 850 configured to perform all or part of the processes described herein or derivatives thereof.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention.

Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like. A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The foregoing merely illustrates the principles of the disclosure. It will thus be appreciated that those skilled in the art will be able to devise various arrangements that, although not explicitly described or shown herein, embody the principles of the disclosure and are included within its spirit and scope. Furthermore, all examples and conditional language recited herein are principally intended to be only for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future.

What is claimed is:

1. A computer-implemented method for developing an RPA (robotic process automation) workflow, the method comprising:
receiving, from a user, a first selection of a particular activity for inclusion in the RPA workflow;
generating a set of candidate next activities to follow the particular activity in the RPA workflow using a predictive learning model;
for each respective activity of the set of candidate next activities, determining a frequency of users of a global population that selected the respective activity to follow the particular activity in one or more RPA workflows;
assigning a confidence rating to each activity of the set of candidate next activities based on the frequencies of the users using the predictive learning model;
generating a personalized set of suggested next activities for the user by 1) removing one or more activities from the set of candidate next activities based on a comparison of the confidence ratings to a threshold and 2) adding one or more activities to the set of candidate next activities based on activity preferences of the user;
receiving, from the user, a second selection of a selected next activity to follow the particular activity in the RPA workflow;
determining that the selected next activity is not included in the personalized set of suggested next activities; and
in response to determining that the selected next activity is not included in the personalized set of suggested next activities, storing the selected next activity in a training database for re-training the predictive learning model.

2. The computer-implemented method of claim 1, wherein generating a personalized set of suggested next activities for the user comprises:
generating the personalized set of suggested next activities for the user based on a coding style of the user.

3. The computer-implemented method of claim 1, wherein generating a personalized set of suggested next activities for the user comprises:
generating the personalized set of suggested next activities for the user based on past usage patterns of the user.

4. The computer-implemented method of claim 1, wherein generating a set of candidate next activities to follow the particular activity in the RPA workflow using a predictive learning model comprises:
generating the set of candidate next activities using intelligence-based filtering to identify commonly used activities relevant to the RPA workflow.

5. The computer-implemented method of claim 1, further comprising:
re-training the predictive learning model using the training database.

6. The computer-implemented method of claim 5, wherein re-training the predictive learning model using the training database comprises:
re-training the predictive learning model based on at least one of a schedule or a set of triggering conditions.

7. The computer-implemented method of claim 1, wherein the predictive learning model comprises at least one of an artificial intelligence-based filtering model, an artificial intelligence-based deep learning model, or an artificial intelligence-based ranking model.

8. The computer-implemented method of claim 1, further comprising:
selecting the predictive learning model from a plurality of predictive learning models based on a performance of the plurality of predictive learning models.

9. The computer-implemented method of claim 1, further comprising:
monitoring activities selected for inclusion in the RPA workflow in substantially real-time.

10. A system for developing an RPA (robotic process automation) workflow, the system comprising:
at least one processor; and
a memory storing computer instructions, which when executed by the at least one processor, cause the system to perform operations comprising:
receiving, from a user, a first selection of a particular activity for inclusion in the RPA workflow;
generating a set of candidate next activities to follow the particular activity in the RPA workflow using a predictive learning model;
for each respective activity of the set of candidate next activities, determining a frequency of users of a global population that selected the respective activity to follow the particular activity in one or more RPA workflows;
assigning a confidence rating to each activity of the set of candidate next activities based on the frequencies of the users using the predictive learning model;
generating a personalized set of suggested next activities for the user by 1) removing one or more activities from the set of candidate next activities based on a comparison of the confidence ratings to a threshold and 2) adding one or more activities to the set of candidate next activities based on activity preferences of the user;
receiving, from the user, a second selection of a selected next activity to follow the particular activity in the RPA workflow;
determining that the selected next activity is not included in the personalized set of suggested next activities; and
in response to determining that the selected next activity is not included in the personalized set of suggested next activities, storing the selected next activity in a training database for re-training the predictive learning model.

11. The system of claim 10, wherein generating a personalized set of suggested next activities for the user comprises:
generating the personalized set of suggested next activities for the user based on a coding style of the user.

12. The system of claim 10, wherein generating a personalized set of suggested next activities for the user comprises:
generating the personalized set of suggested next activities for the user based on past usage patterns of the user.

13. The system of claim 10, wherein generating a set of candidate next activities to follow the particular activity in the RPA workflow using a predictive learning model comprises:
generating the set of candidate next activities using intelligence-based filtering to identify commonly used activities relevant to the RPA workflow.

14. The system of claim 10, the operations further comprising:
monitoring activities selected for inclusion in the RPA workflow in substantially real-time.

15. A non-transitory computer-readable medium storing computer program instructions for developing an RPA (robotic process automation) workflow, the computer program instructions, when executed on at least one processor, cause the at least one processor to perform operations comprising:
receiving, from a user, a first selection of a particular activity for inclusion in the RPA workflow;
generating a set of candidate next activities to follow the particular activity in the RPA workflow using a predictive learning model;
for each respective activity of the set of candidate next activities, determining a frequency of users of a global population that selected the respective activity to follow the particular activity in one or more RPA workflows;
assigning a confidence rating to each activity of the set of candidate next activities based on the frequencies of the users using the predictive learning model;
generating a personalized set of suggested next activities for the user by 1) removing one or more activities from the set of candidate next activities based on a comparison of the confidence ratings to a threshold and 2) adding one or more activities to the set of candidate next activities based on activity preferences of the user;
receiving, from the user, a second selection of a selected next activity to follow the particular activity in the RPA workflow;
determining that the selected next activity is not included in the personalized set of suggested next activities; and
in response to determining that the selected next activity is not included in the personalized set of suggested next activities, storing the selected next activity in a training database for re-training the predictive learning model.

16. The non-transitory computer-readable medium of claim 15, the operations further comprising:
re-training the predictive learning model using the training database.

17. The non-transitory computer-readable medium of claim 16, wherein re-training the predictive learning model using the training database comprises:
re-training the predictive learning model based on at least one of a schedule or a set of triggering conditions.

18. The non-transitory computer-readable medium of claim 15, wherein the predictive learning model comprises at least one of an artificial intelligence-based filtering model, an artificial intelligence-based deep learning model, or an artificial intelligence-based ranking model.

19. The non-transitory computer-readable medium of claim 15, the operations further comprising:
selecting the predictive learning model from a plurality of predictive learning models based on a performance of the plurality of predictive learning models.

20. The non-transitory computer-readable medium of claim 15, the operations further comprising:
monitoring activities selected for inclusion in the RPA workflow in substantially real-time.
